(19) United States
(12) Patent Application Publication
(10) Pub. No.: US 2002/0044249 A1
(43) Pub. Date: Apr. 18, 2002

(54) Liquid crystal display device

(76) Inventor: Naoto Hirota, Toyokawa-shi (JP)

Correspondence Address: Muramatsu & Associates, 7700 Irvine Center Drive, Suite 225, Irvine, CA, 92618, US

(21) Appl. No.: 09/928,182

(22) Filed: Aug. 10, 2001

Related U.S. Application Data
(63) Continuation-in-part of application No. 09/142,448, filed on Sep. 3, 1998.

(30) Foreign Application Priority Data
Apr. 16, 1996 (JP) 8-158741
Apr. 15, 1997 (JP) PCT/JP97/01304

(51) Int. Cl. G02F 1/1343

(52) U.S. Cl. 349/146; 349/110

(57) ABSTRACT

An active matrix type liquid crystal display device having improved visual field angle characteristics and display quality with less residual image. The electrodes, signal lines and the active elements are so constituted that an electric field can be applied to the liquid crystal layer substantially in parallel with the substrate. The signal lines, pixel electrodes, and common electrodes are zigzagged within a range ±1 to ±30 degrees relative to the alignment direction for the P-type liquid crystal. The signal lines, pixel electrodes, and common electrodes are zigzagged within a range between 60-120 degrees except 90 degrees relative to the alignment direction for the N-type liquid crystal. The color filters including black masks can also be zigzagged.

This is a continuation-in-part of U.S. patent application No. 09/142,448 filed Sep. 3, 1998.

### FIELD OF THE INVENTION

This invention relates to an active matrix type liquid crystal display device which has improved visual field angle characteristics and high display quality with less residual image by utilizing bent electrodes.

### BACKGROUND OF THE INVENTION

A conventional technology for applying an electric field to a liquid crystal composition layer is proposed, for instance, in Japanese Laid-Open Patent Publication No. 7-36058 and No. 7-159786 in which an electric field is applied to a pair of comb like electrodes formed on a substrate of an active matrix type liquid crystal display device. Here, within the context of this patent specification, a display system in which a direction of a primary electric field applied to a liquid crystal composition layer is substantially parallel with a surface of the substrate is referred to as a transverse electric field system.

FIG. 1 shows such a conventional example of a transverse electric field system. In this example, comb like pixel electrodes 5 and common electrodes 6 are straight and aligned in parallel with one another.

In the above transverse electric field system having a conventional pixel electrode structure of FIG. 1, it is known that visual field angle characteristics will change drastically with the change of a pretilt angle as shown in FIG. 10. Thus, in order to achieve good visual angle characteristics in the transverse electric field system, a combination of an alignment layer of a very small pretilt angle and a liquid crystal layer is required. According to the experiment, it is desirable that a pretilt angle is less than one (1) degree as shown in FIG. 10.

However, in a vertical electric field system incorporated in liquid crystal displays most widely used today have a pretilt angle of 3-8 degrees between an alignment layer and a liquid crystal layer. A vertical electric field system is a display system wherein a direction of a primary electric field is almost vertical to the surface of a substrate. When an alignment layer and a liquid crystal layer with one (1) degree of pretilt angle are used in a liquid crystal display of a vertical electric field system, a reverse tilt domain will be created by the electric field of video signal lines and pixel electrodes, resulting in significant deterioration in the display quality.

Because of the foregoing reasons, a set of alignment layer and liquid crystal layer to be used in a liquid crystal display system based on the transverse electric field system is different from a set of alignment layer and liquid crystal layer to be used in a liquid crystal display system based on the vertical electric field system. When producing liquid crystal display devices of different display systems by the same production facilities, alignment layers and liquid crystal layers must be frequently changed, which decreases a production efficiency.

### SUMMARY OF THE INVENTION

Therefore, it is an object of the present invention to provide a liquid crystal display device which solves the problem described above.

It is another object of the present invention to provide a liquid crystal display device which is able to incorporate the same alignment layer and liquid crystal layer without regard to whether the transverse electric field system or the vertical electric field system, thereby dramatically increasing the production efficiency.

This invention is a liquid crystal display device which is comprised of a substrate, scanning lines, video signal lines, thin film transistors provided at crossing points of the scanning lines and the video signal lines, liquid crystal drive electrodes connected to the thin film transistors, an active matrix substrate having at least a portion thereof a common electrode which faces the liquid crystal drive electrodes, an opposing substrate which opposedly faces the active matrix substrate, and a liquid crystal layer held between the active matrix substrate and the opposing substrate.

In one aspect of the present invention, when using the liquid crystal of positive dielectric constant anisotropy (P-type liquid crystal), the video signal lines, the pixel electrodes (liquid crystal drive electrodes) and common electrodes are bent relative to the alignment direction of the liquid crystal within the angle ranging from ±1 to ±30 degrees.

In another aspect of the present invention, when using the liquid crystal of positive dielectric constant anisotropy (P-type liquid crystal), the scanning lines, the pixel electrodes (liquid crystal drive electrodes) and common electrodes are bent relative to the alignment direction of the liquid crystal within the angle ranging from ±1 to ±30 degrees.

In a further aspect of the present invention, when using the liquid crystal of negative dielectric constant anisotropy (N-type liquid crystal), the video signal lines, the pixel electrodes (liquid crystal drive electrodes) and common electrodes are bent relative to the alignment direction of the liquid crystal within the angle ranging from 60 degrees to 120 degrees except 90 degrees.

In a further aspect of the present invention, when using the liquid crystal of negative dielectric constant anisotropy (N-type liquid crystal), the scanning lines, the pixel electrodes (liquid crystal drive electrodes) and common electrodes are bent relative to the alignment direction of the liquid crystal within the angle ranging from 60 degrees to 120 degrees except 90 degrees.

In a further aspect of the present invention, a color filter and a black mask are incorporated which are bent in the angle which is the same as that of the video signal lines and the scanning lines used in the above noted various aspects of the present invention.

By incorporating the above described structures in the liquid crystal display device, the liquid crystal molecules rotate in two opposing directions, left rotation and right rotation, respectively, within the pixel electrodes (liquid crystal drive electrodes) and the common electrodes as shown in FIGS. 4 and 6 when the transverse electric field is applied to the pixel electrodes.

In the conventional configuration of FIG. 1, only one direction of rotational motion is generated in the pixel electrodes when the transverse electric field is applied to the pixel electrodes (liquid crystal drive electrodes) and the common electrodes as shown in FIG. 2. In such a one direction rotational motion, when the pretilt angle is large, disparities of visual field angle property will be induced as shown in FIG. 10.

In contrast, when the two directions of rotational motion, i.e., the rotation in the left and right directions, are generated for the liquid crystal molecules in each pixel electrode, such disparities of visual angle property will not be induced even when the pretilt angle is large.

Thus, in the liquid crystal display device using the structure of the present invention, the combination of the alignment layer and the liquid crystal layer is freely selected without being restricted by the pretilt angle. In other words, the structure and method of the present invention can solve the inherent problems in the conventional transverse electric field system such as an inferior residual image and a response speed.

Further in the present invention, as noted above, the pretilt angle will not adversely affect the performance of the display device even when the combination of the alignment layer and liquid crystal layer of the conventional transverse electric field system is used. Therefore, the production line for the vertical electric field system needs not be changed from the production of the transverse electric field systems, and thus the productivity will not be decreased when different types of liquid crystal display devices have to be produced.

By using the above described structure and methods in the foregoing aspects of the present invention, it is possible to separate the rotation motions of the liquid crystal molecules into two directions in each pixel of each of the colors R, G, and B. Thus, color display with a wider visual field angle cab be achieved.

By using the method and structure in the various aspect of the present invention, a polarization axis of polarizers to be attached to top and bottom surfaces of the liquid crystal display panel can be aligned in a direction either in parallel with major and minor axes of the liquid crystal panel or in perpendicular to the major and minor axes. As a result, a cutting angle of the polarizers can be determined easily, thereby improving the yield in the production of the polarizers.

Further, by using the method and structure of the present invention noted above, in an aligning treatment, a rubbing treatment can be carried out without titling the substrate as shown in FIG. 9. Hence, frictions by the cloth of a rubbing roll are uniformly provided, which prevents unevenness in the rotation of the rubbing roll because of the reduction of the unevenness in the alignment treatment.

### BRIEF DESCRIPTION OF THE DRAWINGS

FIG. 1 is a plan view showing a unit pixel in a transverse electric field system in the conventional technology.

FIG. 2 is a diagram showing an alignment direction of a P-type liquid crystal in a transverse electric field system in the conventional technology.

FIG. 3 is a plan view showing a unit pixel in a transverse electric field system in the present invention.

FIG. 4 is a diagram showing an alignment direction of a P-type liquid crystal in a transverse electric field system in the present invention.

FIG. 5 is a plan view showing a unit pixel in a transverse electric field system in the present invention.

FIG. 6 is a diagram showing an alignment direction of an N-type liquid crystal in pixel electrodes of a transverse electric field system in the present invention.

FIG. 7 is a diagram showing an example of application of a unit pixel in a transverse electric field system of the present invention.

FIG. 8 is a diagram showing a relationship between a polarization axis of a polarizing plate and a liquid crystal panel in the present invention.

FIG. 9 is a diagram showing a relationship between a rubbing roll and a substrate in a rubbing treatment process of the present invention.

FIG. 10 is a diagram showing a pretilt angle of liquid crystal molecules and visual field characteristics in the liquid crystal display using a transverse electric field system in the conventional technology.

FIG. 11 is a cross sectional view of a color filter substrate used in a transverse electric field system.

FIG. 12 is a diagram showing a configuration of a liquid crystal display device including a black mask of a color filter, pixel electrode, common electrodes and video signal lines used in a transverse electric field system.

FIG. 13 is a diagram showing an example of structure with respect to adjacent two pixels in a transverse electric field system of the present invention where the video signal line is sandwiched by the common electrodes.

FIG. 14 is a plan view showing an example of a color filter used in the liquid crystal display device of the present invention.

FIG. 15 is a plan view showing another example of a color filter used in the liquid crystal display device of the present invention.

FIG. 16 is a plan view showing a further example of a color filter used in the liquid crystal display device of the present invention.

FIGS. 17A and 17B are schematic diagrams showing examples of angles in the pixel electrodes, common electrodes or video signal lines where the angles of bent are different from one another.

FIG. 18 is a diagram showing a configuration of a liquid crystal display device which is a modified version of the configuration of FIG. 12.

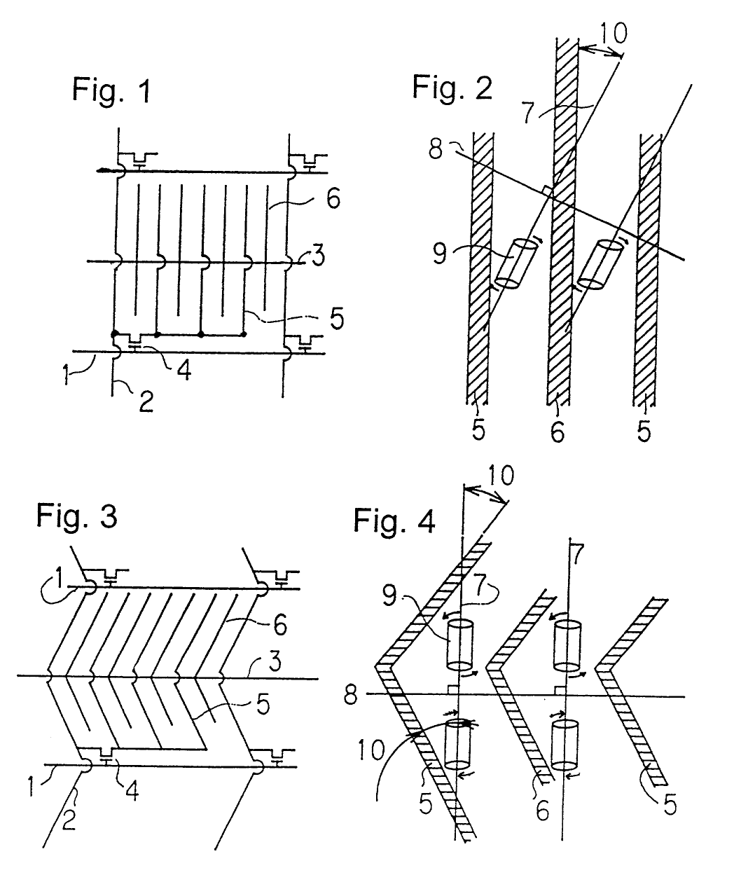

### DETAILED DESCRIPTION OF THE INVENTION

FIGS. 3 and 4 are plan views of a unit pixel showing a basic operational principle of an embodiment of the present invention. In this example, dielectric constant anisotropy of the liquid crystal molecule is positive. In FIG. 3, numeral 1 denotes a scanning line, numeral 2 is a video signal line, numeral 3 is a common electrode, numeral 4 is an active element such as a thin film transistor (TFT), numeral 5 is a pixel electrode (liquid crystal drive electrode), and numeral 6 is a common electrode connected to the common electrode 3.

In FIG. 4, numeral 5 denotes a pixel electrode (liquid crystal drive electrode), numeral 6 is a common electrode connected to the electrode 3, numeral 7 represents an alignment direction of the liquid crystal molecules as well as a polarization axis of a polarizing plate (polarizer), numeral 8 is a polarization axis of the other polarizing plate (polarizer), numeral 9 is a liquid crystal molecule of a positive dielectric constant anisotropy (P-type liquid crystal molecule) under zero electric field, and numeral 10 is an angle (i.e., bent angle) that is formed by crossing the alignment direction of the P-type liquid crystal molecule and the pixel electrode.

As shown in FIGS. 3 and 4, the video signal line 2 and the pixel electrode 5 and the common electrode 6 are so configured that these members are bent relative to the alignment direction of the P-type liquid crystal. The bent angle 10 can be selected so as to show the best display performance as long as the angle is within the range from ±1 to ±30 degrees.

As shown in FIG. 7, there is no limit in the number of bent of the electrodes and signal lines. In the example of FIG. 7, the pixel electrodes 5 and the common electrodes 6 are bent at the upper part, the center and the lower part of each pixel. The bent angle can be selected within the range from ±1 to ±30 degrees. Further, the bent angles can be either symmetrical or asymmetrical as shown in FIGS. 7A and 7B as will be described in more detail later.

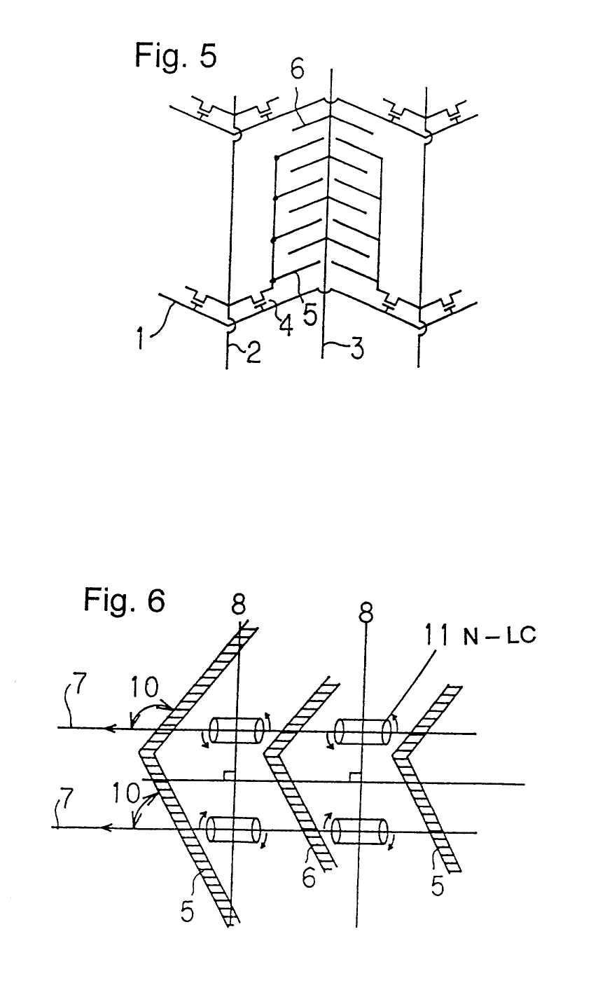

FIGS. 4 and 5 are plan views of a unit pixel showing a basic operational principle of another embodiment of the present invention. In this example, dielectric constant anisotropy of the liquid crystal molecule is positive. As shown in FIGS. 4 and 5, the scanning line 1 and the pixel electrode 5 and the common electrode 6 are so configured as to be bent relative to the alignment direction of the P-type liquid crystal. The bent angle 10 can be selected to be an angle with the best display performance as long as the angle is within the range from ±1 to ±30 degrees. Again, as shown in FIG. 7, there is no limit in the number of bent of the electrodes.

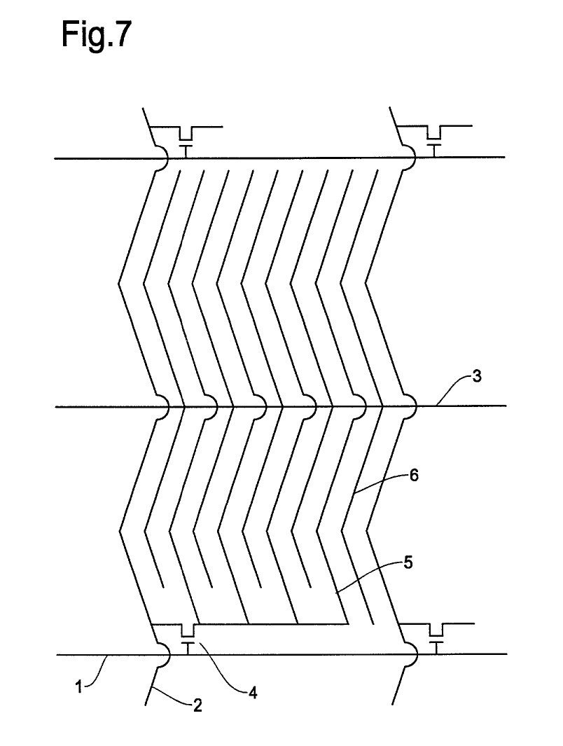

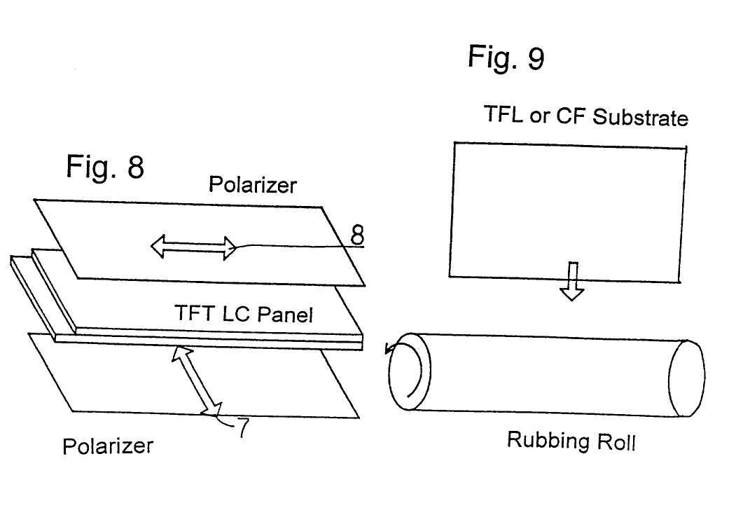

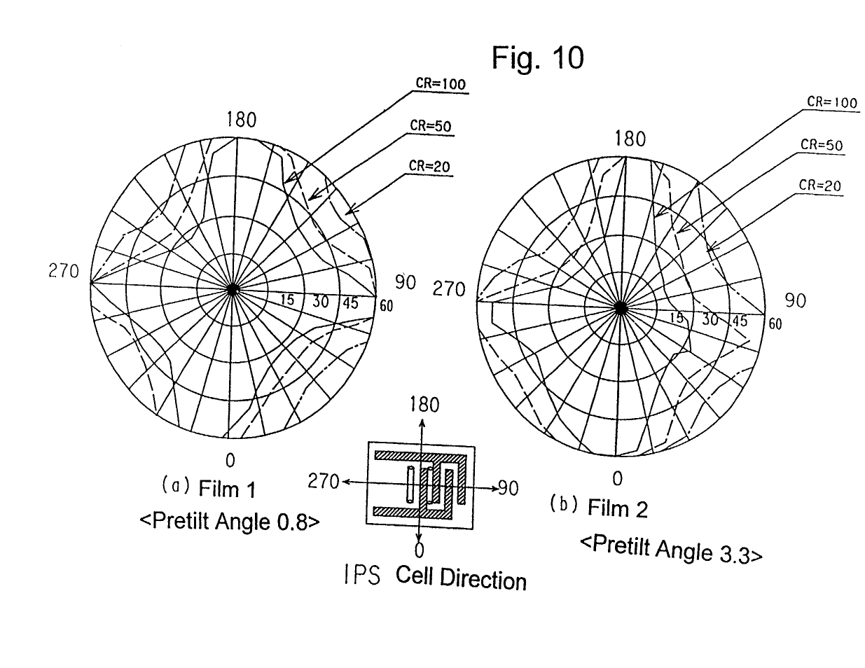

FIGS. 3 and 6 are plan views of a unit pixel showing a basic operational principle of a further embodiment of the present invention. In this example, dielectric constant anisotropy of the liquid crystal molecule is negative. In FIG. 6, numeral 5 designates a pixel electrode (liquid crystal drive electrode), numeral 6 is a common electrode connected to the common electrode 3, numeral 7 represents an alignment direction of the liquid crystal molecule as well as a polarization axis of a polarizing plate (polarizer), numeral 8 is a polarization axis of the other polarizing plate (polarizer), numeral 10 is an angle (i.e., bent angle) that is formed by crossing the alignment direction of the P-type liquid crystal molecule and the pixel electrode, and numeral 11 is a liquid crystal molecule of a negative dielectric constant anisotropy (N-type liquid crystal molecule) under zero electric field.

As shown in FIGS. 3 and 6, the video signal line 2 and the pixel electrode 5 and the common electrode 6 are so configured as to be bent relative to the alignment direction of the N-type liquid crystal. The bent angle 10 can be selected to be an angle with the best display performance as long as the angle is within the range from 60 degrees to 120 degrees except 90 degrees. As shown in FIG. 7, there is no limit in the number of bent of the electrodes. In other words, the number of bent of the electrodes and lines can be not only one but two or more.

As shown in FIGS. 4 and 6, the liquid crystal molecules rotate in the two directions in the pixel electrode (liquid crystal drive electrode) and common electrode when the electric field is produced in the pixel electrodes. In FIG. 4, the liquid crystal molecules 9 rotate in a left rotation direction in the upper part of the drawing and in a right rotation direction in the lower part of the drawing. Similarly, in FIG. 6, the liquid crystal molecules 11 rotate in the directions opposite to each other between the upper and lower parts of the drawing.

FIGS. 5 and 6 are plan views of a unit pixel showing a basic operational principle of a further embodiment of the present invention. In this example, dielectric constant anisotropy of the liquid crystal molecule is negative. As shown in FIGS. 5 and 6, the scanning line 1 and the pixel electrode 5 and the common electrode 6 are so configured as to be bent relative to the alignment direction of the N-type liquid crystal. The bent angle 10 can be selected to be an angle with the best display performance as long as the angle is within the range from 60 degrees to 120 degrees except 90 degrees. Again, as shown in FIG. 7, there is no limit in the number of bent of the electrodes.

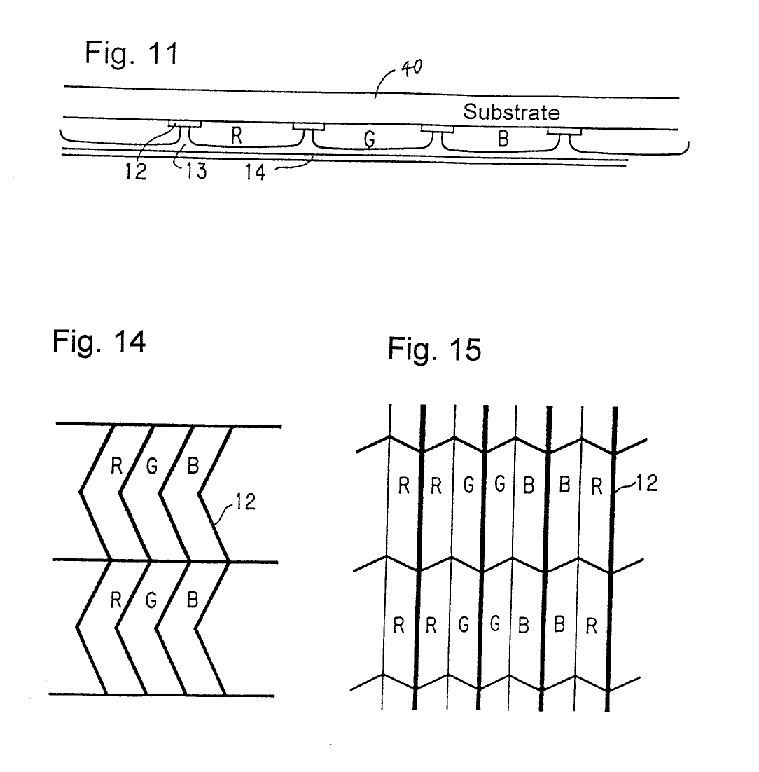

FIGS. 11-15 are cross-section views and plan views of the substrates used in the liquid crystal display device of the present invention viewed mainly from the side of a color filter. The schematic diagram of FIG. 11 shows a cross sectional view of the color filter substrate 40 in the liquid crystal display device of the present invention. Color filter layers for red (R), green (G) and blue (B) are formed on the color filter substrate 40 which is a transparent substrate typically made of glass. In FIG. 11, numeral 12 denotes a black mask to block the light therethrough at the boundaries of the color filters. Numeral 13 is a leveling layer to compensate surface irregularities, numeral 14 is an alignment layer to align the liquid crystal.

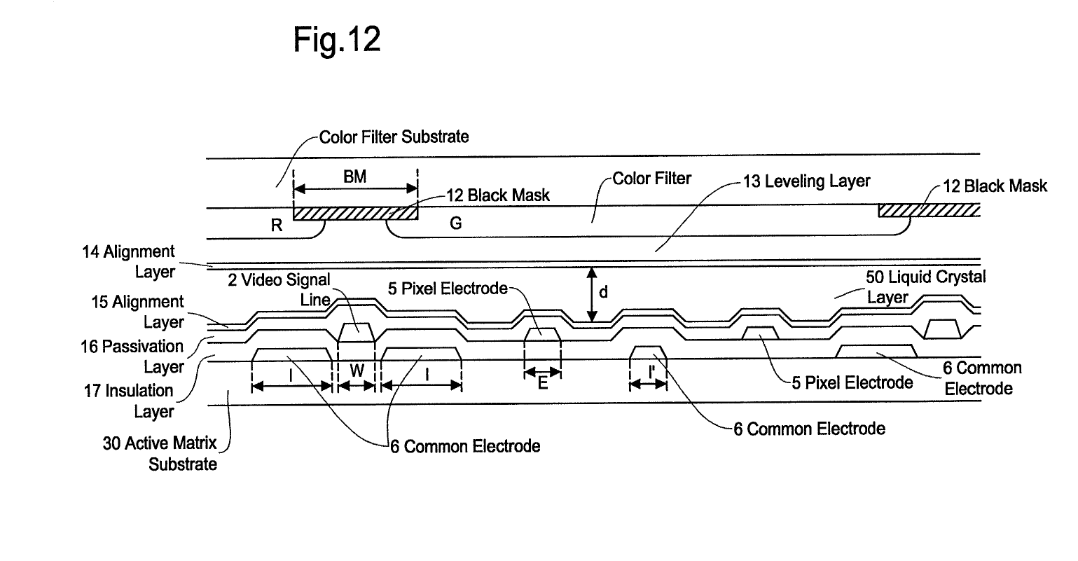

FIG. 12 shows a cross sectional view of a liquid crystal display device 20 of the present invention. The basic structural components in the liquid crystal display device 20 are a color filter substrate 40, an active matrix substrate 30, and a liquid crystal layer 50. The liquid crystal layer 50 is sandwiched between the color filter substrate 40 and the active matrix substrate 30. The color filter substrate 40 is the same as that shown in FIG. 11. In FIG. 12, the black mask 12 has a width BM which will be explained later. The active matrix substrate 30 includes pixel electrodes (liquid crystal drive electrode) 5, common electrodes 6, a video signal line 2, a common electrode 3 connected to the common electrodes 6, an alignment layer 15, a passivation layer 16 and an insulation layer 17. At least either the pixel electrodes 5 or the common electrodes 6 are transparent and their conductivity is less than 10 ohm-centimeters.

A gap (liquid crystal cell gap) d in FIG. 12 represents a distance between the alignment layer 14 of the color filter substrate 40 and the alignment layer 15 of the active matrix substrate 30. A reference character W represents a width of the video signal line 2. A reference character l represents a width of the common electrodes (adjacent common electrodes) 6 which are most adjacent to the video signal line 2, and a reference label l′ represents a width of the common electrodes (inner common electrodes) 6 which are remote from the video signal line 2. Further in FIG. 12, a reference character E represents a width of the pixel electrode (liquid crystal drive electrode) 5.

In the foregoing structure of the liquid crystal display device 20, when the width l of the adjacent common electrodes 6 increases, a shielding effect for the video signal line increases. Thus, it is effective to increase the width l for decreasing the cross talk between the pixels. However, the increase in the width l of the adjacent common electrodes 6 may cause decrease in an aperture ratio. In view of the foregoing, an example of the width 1 of the adjacent common electrodes 6 is about 7-10 μm (micrometer).

Preferably, the width W of the video signal line 2 is slightly smaller than the width l of the adjacent common electrodes 6, for example, by 1 μm. Thus, there is a relationship W<l wherein an example of the width W of the video signal line 2 is in the range of 6-8 μm. As an example, when the width l is 7 μm, the width W is preferably 6 μm, and when the width l is 10 μm, the width W is preferably 8 μm. Since the width l of the adjacent common electrodes 6 is larger than the width W of the video signal line 2 such as by 1 μm or 2 μm, the cross talk can be effectively suppressed. In contrast, if the width l is equal to or smaller than the width W, the cross talk tends to be induced because the electric field of the video signal line 2 affects the pixel electrodes.

In the case where the black mask 12 is conducive, an appropriate width BM of the black mask 12 is smaller than the sum of the width l of the two adjacent common electrodes 6 and the width W of the video signal line 2. However, it is preferable that the width BM of the black mask 12 is larger than the width W of the adjacent common electrode 6 to prevent the lights leaked from the gap between the video signal line 2 and the adjacent common electrodes 6. This relationship is expressed by W<BM<(W+2 l). If the width BM of the black mask 12 is larger than the sum of the width l of the two adjacent common electrodes 6 and the width W of the video signal line 2, i.e., BM>(W+2l), the black mask 12 may obstruct the lights from a quality pixel area when there is an alignment error between the color filter substrate 40 and the active matrix substrate 30.

The width l′ of the inner common electrode 6 in FIG. 12 is about 3-4 μm. A larger width l′ such as 6-7 μm can be used for the purpose of decreasing the drive voltage level. However, it is preferable to make the width l′ smaller for increasing the aperture ratio. By using the width l′ of the inner common electrode 6 which is smaller than the width l of the adjacent common electrodes 6, it is possible to increase the aperture ratio, thereby achieving higher transmittance in the liquid crystal display device.

As noted above, the width l′ of the inner common electrode 6 is about 3-4 μm. The width E of the pixel electrode (liquid crystal drive electrode) 5 is about the same as that of the inner common electrode 6. Thus the width E of the pixel electrode 5 is also about 3-4 82 m. Preferably, the liquid crystal cell gap d is selected to be equal to or larger than the widths l′ and E of the inner common electrode and the pixel electrode, i.e., d≧l′≈E. For example, when the widths l′ and E of the inner common electrode and the pixel electrode is 3-4 μm, an example of the liquid crystal cell gap d is 3.5-4.5 μm.

FIG. 13 is a diagram showing an example of structure with respect to adjacent two pixels in a transverse electric field system of the present invention where the video signal line 2 is sandwiched by the adjacent common electrodes 6. As described with reference to FIG. 12, two common electrodes 6 which are mostly adjacent to the video signal line 2 sandwich the video signal line 2. The adjacent common electrodes 6 have the width l which is larger than the width l′ of the inner common electrodes 6. The advantage of this structure is that the pixel electrodes are not affected by the video signal line, thereby substantially reducing the cross talk.

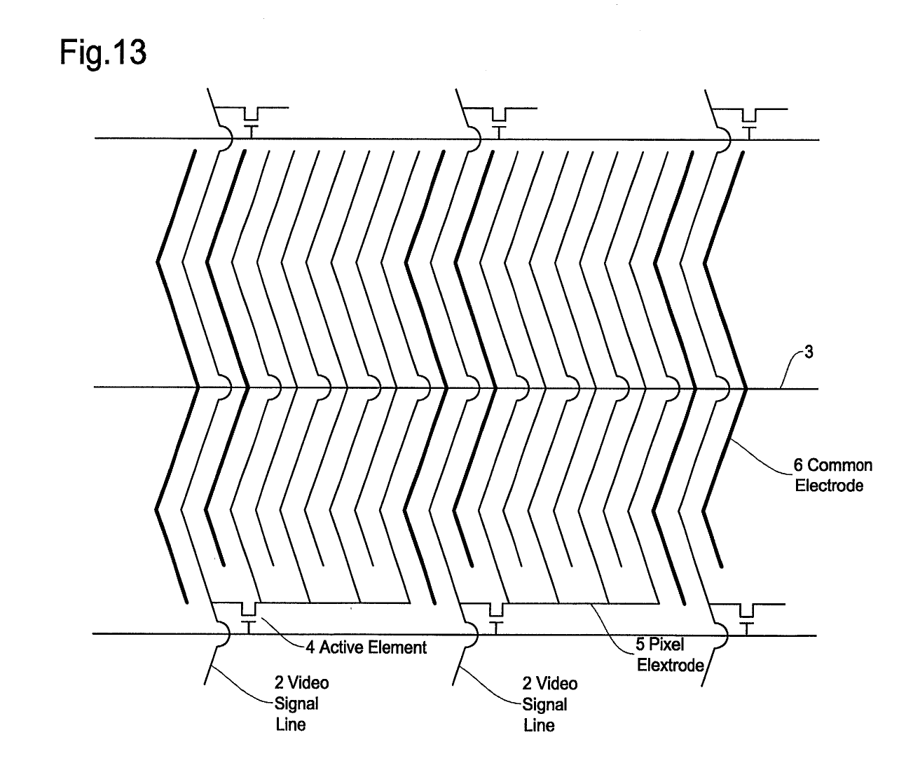

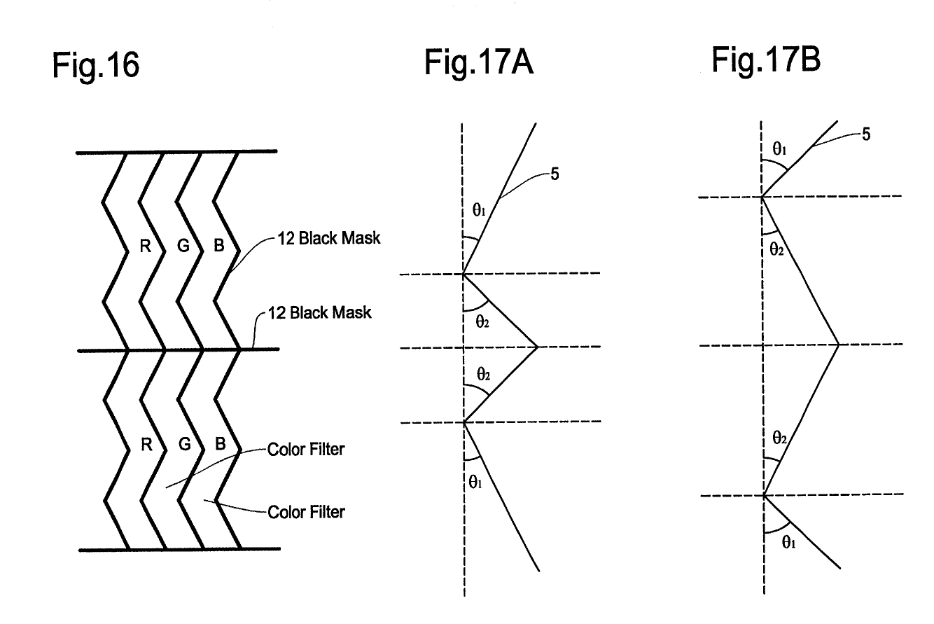

In the further aspect of the present invention, as shown in FIGS. 14-16, the color filters (color filter layers) R, G, B and the black mask 12 are also bent to be associated with the structures in the foregoing embodiments. In FIG. 14, the black mask 12 and color filters in the vertical direction are zigzagged while in FIG. 15, the black mask 12 and color filters in the horizontal direction are zigzagged. There is no limit in the number of bent of the color filters and black masks as well as the electrodes and video signal lines. Thus, as shown in FIG. 16, the color filters and the black masks 12 are bent two or more times for each pixel.

In the present invention, the angle of bent relative to the alignment direction needs not be the same throughout the unit pixel. FIGS. 17A and 17B are schematic diagrams showing examples of angles in the pixel electrodes, common electrodes and video signal lines where the angles of bent are different from one another. FIG. 17A shows the situation where the angle θ₁ is smaller than the angle θ₂, and FIG. 17B shows the situation where the angle θ₁ is larger than the angle θ₂. Although only two different angles are shown in FIGS. 17A and 17B, three or more different angles can also be used. In using the liquid crystal of positive dielectric constant anisotropy, such angles of bents must be within the range from ±1 to ±30 degrees relative to the alignment direction of the liquid crystal. In using the liquid crystal of negative dielectric constant anisotropy, such angles of bents must be within the range from 60 degrees to 120 degrees except 90 degrees.

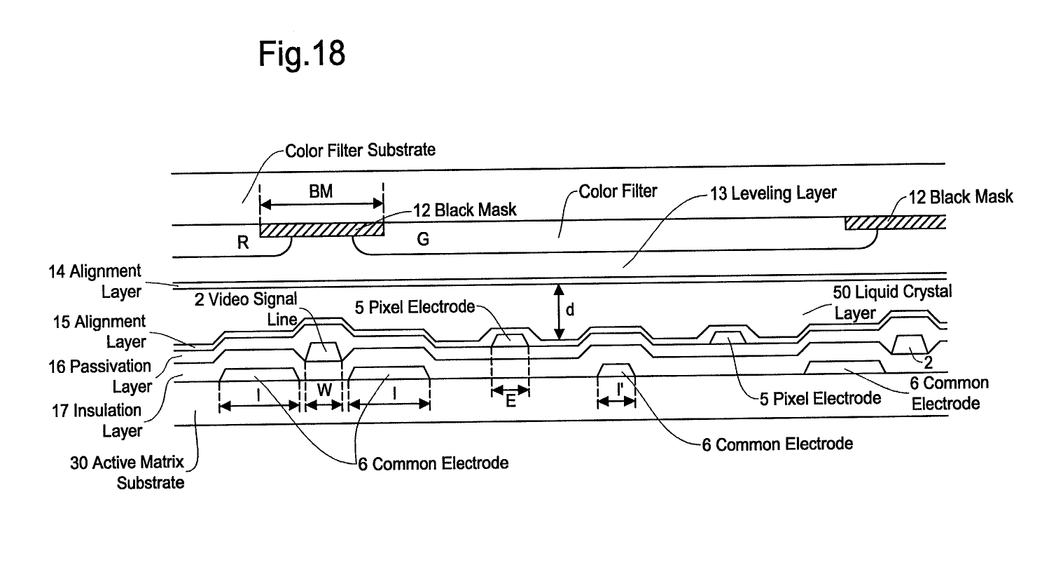

FIG. 18 shows a cross sectional view of a liquid crystal display device 20 of the present invention which is a modified version of FIG. 12. In this example, the pixel electrodes are formed on the passivation layer because of the production process different from that of FIG. 12.

According to the present invention, by incorporating the zigzag structure of the electrodes, signal lines, filters and black masks, it is possible to avoid the deterioration of the visual field angle even when the tilt angle is increased. Further, by the relationships among the sizes of the electrodes and signal lines, the cross talk is effectively minimized while the aperture ratio is increased. Therefore, it is possible to achieve a large screen, wide visual angle liquid crystal display device with high production yield and low production cost.

Although only a preferred embodiment is specifically illustrated and described herein, it will be appreciated that many modifications and variations of the present invention are possible in light of the above teachings and within the purview of the appended claims without departing the spirit and intended scope of the invention.

What is claimed is:

1. A liquid crystal display device having a plurality of pixels, comprising:
a color filter substrate;
an active matrix substrate;
a liquid crystal layer provided between said color filter substrate and said active matrix substrate;
a plurality of video signal lines provided on said active matrix substrate;
a plurality of pixel electrodes provided on said active matrix substrate;
a plurality of common electrodes provided on said active matrix substrate;
a plurality of active elements connected to said pixel electrodes and said video signal lines;
wherein each of said pixel electrodes and common electrodes is bent two or more times for each pixel to form a zigzag shape.

2. A liquid crystal display device as defined in claim 1, wherein, when using liquid crystal of positive dielectric constant anisotropy, angles of bent of said pixel electrodes and common electrodes relative to the alignment direction of the liquid crystal are within a range from 0 to 30 degrees.

3. A liquid crystal display device as defined in claim 1, wherein, when using liquid crystal of negative dielectric constant anisotropy, angles of bent of said pixel electrodes and common electrodes relative to the alignment direction of the liquid crystal are within a range from 60 to 120 degrees except 90 degrees.

4. A liquid crystal display device having a plurality of pixels, comprising:
a color filter substrate;
an active matrix substrate;
a liquid crystal layer provided between said color filter substrate and said active matrix substrate;
a plurality of video signal lines provided on said active matrix substrate;
a plurality of pixel electrodes provided on said active matrix substrate;
a plurality of common electrodes provided on said active matrix substrate;
a plurality of active elements connected to said pixel electrodes and said video signal lines;
wherein each of said pixel electrodes and common electrodes is bent one or more times for each pixel and wherein said video signal line is sandwiched by two common electrodes which are most adjacent to said video signal line.

5. A liquid crystal display device as defined in claim 4, further includes a black mask on said color filter substrate for blocking lights, and wherein, widths of elements in the display device are expressed as:
W<BM<(W+2l) (a)
W<l (b)
where W is a width of said video signal line, l is a width of said common electrode most adjacent to said video signal line, and BM is a width of said black mask.

6. A liquid crystal display device as defined in claim 4, wherein a width of said common electrodes most adjacent to said video signal line is larger than that of other common electrodes.

7. A liquid crystal display device having a plurality of pixels, comprising:
a color filter substrate for mounting color filters thereon;
an active matrix substrate;
a liquid crystal layer provided between said color filter substrate and said active matrix substrate;
a plurality of video signal lines provided on said active matrix substrate;
a plurality of pixel electrodes provided on said active matrix substrate;
a plurality of common electrodes provided on said active matrix substrate;
a plurality of active elements connected to said pixel electrodes and said video signal lines;
wherein each of said color filters is bent two or more times for each pixel in a zigzag manner.

8. A liquid crystal display device having a plurality of pixels, comprising:
a color filter substrate for mounting color filters thereon;
an active matrix substrate;
a liquid crystal layer provided between said color filter substrate and said active matrix substrate;
a plurality of video signal lines provided on said active matrix substrate;
a plurality of pixel electrodes provided on said active matrix substrate;
a plurality of common electrodes provided on said active matrix substrate;
a plurality of active elements connected to said pixel electrodes and said video signal lines;
wherein each of said pixel electrodes, common electrodes, and video signal lines is bent two or more times for each pixel to form a zigzag shape.

9. A liquid crystal display device as defined in claim 8, wherein, when using liquid crystal of positive dielectric constant anisotropy, angles of bent of said pixel electrodes, common electrodes and video signal lines relative to the alignment direction of the liquid crystal are within a range from 0 to 30 degrees.

10. A liquid crystal display device as defined in claim 8, wherein, when using liquid crystal of negative dielectric constant anisotropy, angles of bent of said pixel electrodes, common electrodes and video signal lines relative to the alignment direction of the liquid crystal are within a range from 60 to 120 degrees except 90 degrees.

11. A liquid crystal display device as defined in claim 8, further includes a black mask on said color filter substrate for blocking lights, and wherein said color filters and said black mask are bent two or more times for each pixel in a zigzag manner.

12. A liquid crystal display device having a plurality of pixels, comprising:
a color filter substrate;
an active matrix substrate;
a liquid crystal layer provided between said color filter substrate and said active matrix substrate;
a plurality of video signal lines provided on said active matrix substrate;
a plurality of pixel electrodes provided on said active matrix substrate;
a plurality of common electrodes provided on said active matrix substrate;
a plurality of active elements connected to said pixel electrodes and said video signal lines;
wherein each of said pixel electrodes, common electrode and video signal lines is bent one or more times for each pixel and wherein said video signal line is sandwiched by two common electrodes which are most adjacent to said video signal line.

13. A liquid crystal display device as defined in claim 12, further includes a black mask on said color filter substrate for blocking lights, and wherein widths of elements in the display device are expressed as:
W<BM<(W+2l) (a)
W<l (b)
where W is a width of said video signal line, l is a width of said common electrode most adjacent to said video signal line, and BM is a width of said black mask.

14. A liquid crystal display device as defined in claim 12, wherein a width of said common electrodes most adjacent to said video signal line is larger than that of other common electrodes.

15. A liquid crystal display device as defined in claim 2, wherein said pixel electrodes and common electrodes are bent by two or more different angles for each pixel.

16. A liquid crystal display device as defined in claim 9, wherein said pixel electrodes, common electrodes and video signal lines are bent by two or more different angles for each pixel.

17. A liquid crystal display device as defined in claim 3, wherein said pixel electrodes and common electrodes are bent by two or more different angles for each pixel.

18. A liquid crystal display device as defined in claim 10, wherein said pixel electrodes, common electrodes and video signal lines are bent by two or more different angles for each pixel.

19. A liquid crystal display device as defined in claim 4, wherein a width of pixel electrodes and common electrodes is equal to or smaller than a liquid crystal cell gap where the liquid crystal cell gap represents a distance between said color filter substrate and said active matrix substrate.

20. A liquid crystal display device as defined in claim 12, wherein a width of pixel electrodes and common electrodes is equal to or smaller than a liquid crystal cell gap where the liquid crystal cell gap represents a distance between said color filter substrate and said active matrix substrate.

21. A liquid crystal display device as defined in claim 4, wherein at least either said pixel electrodes or said common electrodes are transparent and have conductivity which is smaller than 10 ohm-centimeters.

22. A liquid crystal display device as defined in claim 12, wherein at least either said pixel electrodes or said common electrodes are transparent and have conductivity which is smaller than 10 ohm-centimeters.
